(19) United States
(12) Patent Application Publication
(10) Pub. No.: US 2014/0375682 A1
(43) Pub. Date: Dec. 25, 2014

(54) INTERACTIVE CONTROL OVER AUGMENTED REALITY CONTENT

(71) Applicant: International Business Machines Corporation, Armonk, NY (US)

(72) Inventors: Lydia M. Do, Raleigh, NC (US); Pamela A. Nesbitt, Ridgefield, CT (US); Kevin G. Paterson, San Antonio, TX (US)

(21) Appl. No.: 13/925,933

(22) Filed: Jun. 25, 2013

(51) Int. Cl. G06T 19/00

(52) U.S. Cl. CPC G06T 19/006
USPC 345/633

(57) ABSTRACT

In a method for performing a computer action to manage a visual display on an augmented reality computing device, parameters are received representing a user command entered on at least one tactile sensor of an augmented reality computing device. One or more processors determine a computer action represented by the user command. In response to determining the computer action, modifying the display of content at a specific location on the augmented reality computing device.

### FIELD OF THE INVENTION

The present invention relates generally to the field of virtual reality software and more particularly to content display controls.

### BACKGROUND OF THE INVENTION

Augmented reality (AR) provides a live, direct or indirect, view of a physical, real-world environment coupled, or augmented, with computer-generated content. The computer-generated content includes, but is not limited to: (i) sound; (ii) video; (iii) graphics; or (iv) other data intermixed while viewing the real world. The augmentation is overlaid in and around the real-time environment and may include semantic context. For instance, stock information might be displayed while viewing a corporation's signage, or player statistics might be displayed for a tennis player while watching a tennis match. As a result, the technology functions by enhancing one's current perception of reality.

Augmented reality rendering devices include, but are not limited to: (i) optical projection systems; (ii) monitors; (iii) handheld devices; (iv) and display systems worn on one's person, usually surrounding the head or in the field-of-view of one's eyes.

A head-mounted display (HMD) is one device that is worn as a helmet. HMDs place images of both the physical world and virtual content over the user's field-of-view. HMDs may employ sensors that allow the rendering system to align projected virtual content to the projected physical world.

Augmented reality content can be rendered on devices which in appearance are similar to conventional eyeglasses. These AR eyeglasses may employ cameras to intercept the real world view and re-display it coupled with augmented content, which is viewed through the eyepieces.

### SUMMARY

Embodiments of the present invention disclose a method, computer program product, and system for performing a computer action to manage a visual display on an augmented reality computing device. The method comprises receiving parameters representing a user command entered on at least one tactile sensor of an augmented reality computing device. One or more processors determine a computer action represented by the user command. The method further comprises modifying the display of content at a specific location on the augmented reality computing device, in response to determining the computer action.

### BRIEF DESCRIPTION OF THE SEVERAL VIEWS OF THE DRAWINGS

FIG. 1 is a diagram of a distributed data processing environment in accordance with one embodiment of the present invention.

FIG. 2 is a flowchart depicting operational steps of a UI (User Interface) control program for determining and issuing actions to modify the display of augmented reality content at a specific location on an augmented reality computing device, in accordance with one embodiment of the present invention.

FIGS. 3A through 3C, in aggregate, illustrate one example of operational steps of a UI (User Interface) control program, operating on an augmented reality computing device within the distributed data processing environment of FIG. 1, in accordance with one embodiment of the present invention

FIG. 4 depicts, in tabular form, a preference repository, in accordance with one embodiment of the present invention.

FIG. 5 is a block diagram of components of an augmented reality computing device and a server computer in accordance with one embodiment of the present invention.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer-readable medium(s) having computer-readable program code/instructions embodied thereon.

Any combination of computer-readable media may be utilized. Computer-readable media may be a computer-readable signal medium or a computer-readable storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of a computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device.

Program code embodied on a computer-readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on a user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer, other programmable data processing apparatus, or other devices to function in a particular manner, such that the instructions stored in the computer-readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer-implemented process such that the instructions which execute on the computer or other programmable apparatus provide processes for implementing the functions/acts specified in the flowchart and/or block diagram block or blocks.

The present invention will now be described in detail with reference to the Figures. The following Figures provide an illustration of one embodiment. The embodiment, taken in part or in whole, does not imply any limitations with regard to the environments in which different embodiments may be implemented.

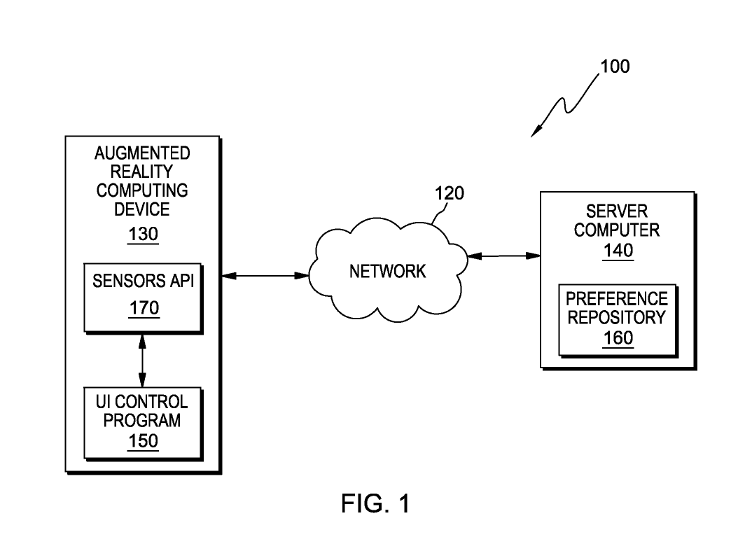

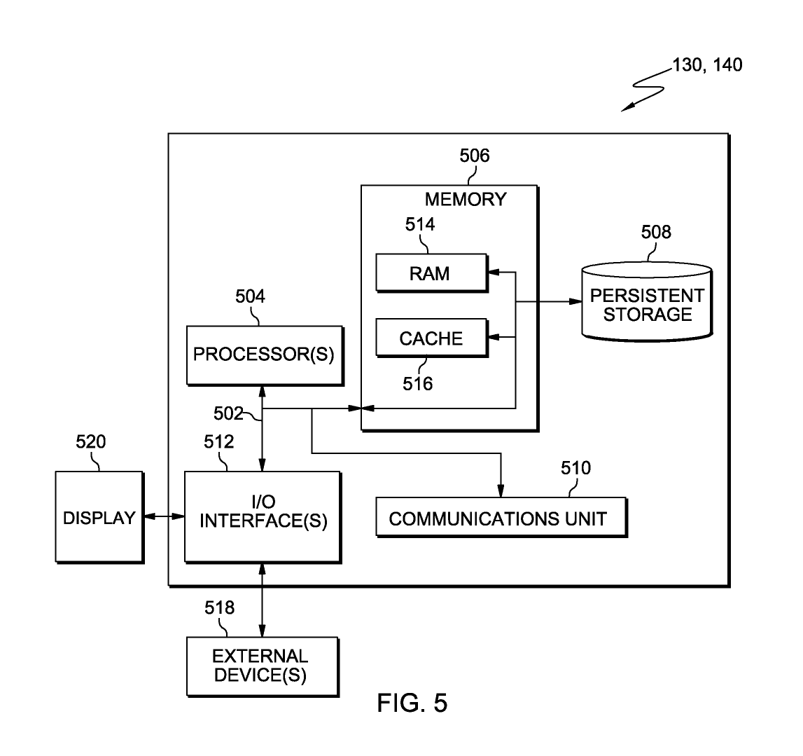

FIG. 1 depicts a diagram of distributed data processing environment 100 in accordance with one embodiment of the present invention. Distributed data processing environment 100 includes augmented reality computing device 130 and server computer 140 interconnected over network 120. Augmented reality computing device 130 and server computer 140 may each include components as depicted in further detail in FIG. 5. Network 120 may be a local area network (LAN), a wide area network (WAN) such as the Internet, any combination thereof, or any combination of connections and protocols that will support communications between augmented reality computing device 130 and server computer 140 in accordance with embodiments of the invention. Network 120 may include wired, wireless, or fiber optic connections. Distributed data processing environment 100 may include additional servers, augmented reality computing devices, or other devices not shown.

Server computer 140 may be a management server, a web server, or any other electronic device or computing system capable of receiving and sending data, and capable of communicating with devices, such as augmented reality computing device 130, via network 120. In other embodiments, server computer 140 may represent a server computing system utilizing multiple computers as a server system, such as in a cloud computing environment.

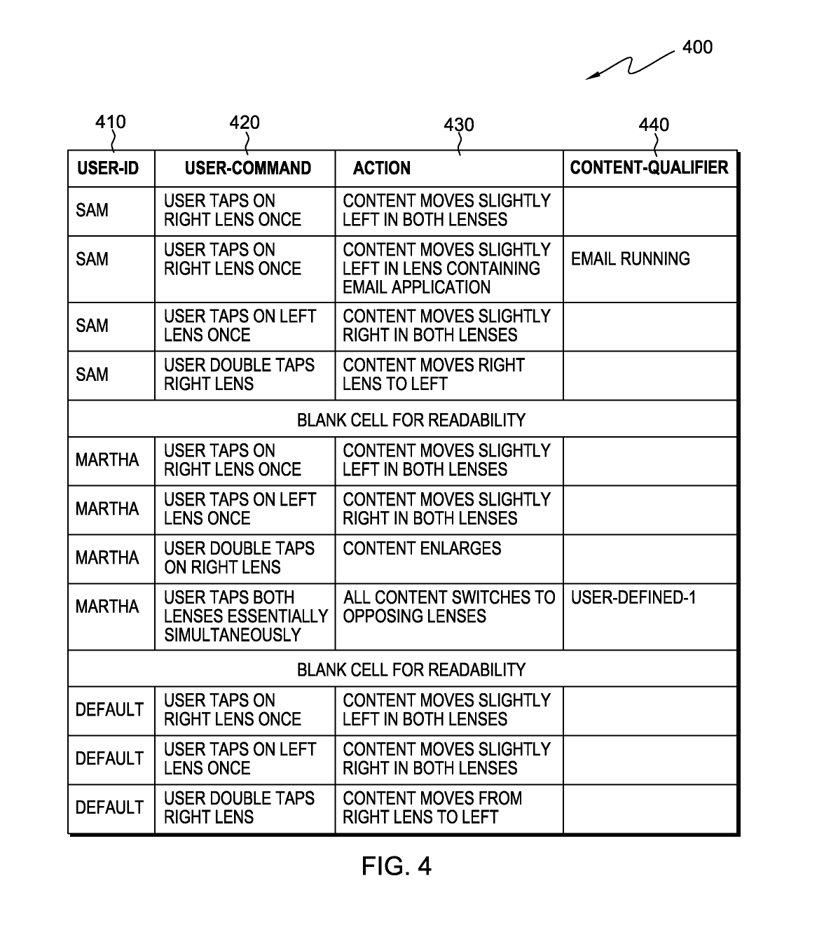

In one embodiment, server computer 140 contains preference repository 160. Preference repository 160 holds user preferences that each represent a mapping between user commands and actions taken by augmented reality computing device 130. The actions taken by augmented reality computing device 130 include actions to modify the display of content at a specific location on augmented reality computing device 130. Examples of actions to modify the display of content at a specific location on augmented reality computing device 130 are shown in FIG. 4 as action 430. In one embodiment, preference repository 160 is a data file that may be written to and read by user interface (UI) control program 150. In some embodiments, preference repository 160 may be a database such as an Oracle® database. In other embodiments, preference repository 160 may be located on augmented reality computing device 130, another server, or another computing device, provided that preference repository 160 is accessible to UI control program 150.

Additionally, server computer 140 may contain other software, not shown in FIG. 1, capable of performing other conventional services that include, but are not limited to: (i) web page delivery; (ii) mail server; (iii) print server; (iv) gaming server; and (v) application server.

Augmented reality computing device 130 is a computing system capable of displaying content to a user. For example, augmented reality computing device 130 may be eyeglasses with a right lens and a left lens, having the capability of projecting content in the field-of-view of a user. In general, augmented reality computing device 130 may be any device such as an optical projection system, monitor, handheld device, or display system worn on a user's person, or physically proximate to a user's person, capable of projecting content to the user. Augmented reality computing device 130 contains two software programs, UI control program 150 and sensor application programming interface (API) 170.

In one embodiment of the present invention, augmented reality computing device 130 contains a plurality of tactile sensors. The tactile sensors may be integrated: (i) within the assembly of augmented reality computing device 130; (ii) around the edge of augmented reality computing device 130; or (iii) in any location that would allow the user to access the sensor or interact with the sensor. A tactile sensor is a device that may be sensitive to touch, force, or pressure, light, or heat, for example. Tactile sensors may include piezoresistive, piezoelectric, capacitive and elastoresistive sensors, for example. A tactile sensor may receive and respond to a stimulus from a user's touch. A sensitivity of a sensor indicates how much the output of the sensor changes when the measured quantity changes. Tactile sensors can be deployed wherever interactions between a contact surface and a user are to be measured.

In one embodiment, the plurality of tactile sensors are configured to detect if a user is touching a respective sensor. Generally, data from the plurality of tactile sensors is accessed by a program, such as UI control program 150, by calling an Application Programming Interface (API), sensors API 170, provided with augmented reality computing device 130.

Sensors API 170 contains the instructions to interface with the plurality of tactile sensors described above. In one embodiment, the data from the plurality of tactile sensors is in a raw form. Sensors API 170 contains the instructions to transform the raw data into parameters representing a user command. Sensors API 170 provides UI control program 150 with the parameters representing the user command. In another embodiment, sensors API 170 minimally processes the raw data from the one or more tactile sensors. The computer instructions to translate the tactile sensor raw data into parameters representing a user command usable by UI control program 150 can be encapsulated within UI control program 150.

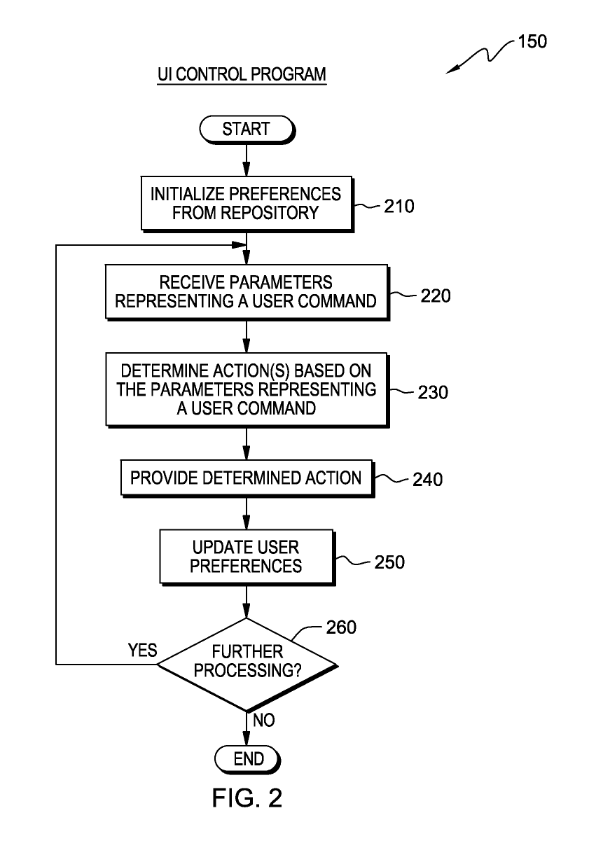

The parameters representing the user command transferred from sensors API 170 are interpreted by UI control program 150 using the mappings from preference repository 160 to determine a new action for augmented reality computing device 130; the new action is sent by UI control program 150 to augmented reality computing device 130. The actions taken by augmented reality computing device 130 include actions to modify the display of content at a specific location on augmented reality computing device 130. UI control program 150 is described in further detail in reference to FIG. 2.

Embodiments of the present invention recognize that previous solutions do not supply sufficient control of the user experience, both from the perspective of user preference and user need. For example, a user might have diminished vision in one eye. Consequently, the user has a genuine need for the rendering of AR content on one frame, or section of the device, over another. Additionally, embodiments of the present invention recognize the lack of user feedback in the adaptation of learned preferences.

FIG. 2 is a flowchart depicting operational steps of UI control program 150 for determining and issuing actions to modify the display of augmented reality content at a specific location on an augmented reality computing device, in accordance with one embodiment of the present invention.

In step 210, UI control program 150 initializes user preferences from preference repository 160. In one embodiment, UI control program 150 communicates with server computer 140 to request specific information on user preferences from preference repository 160. A user of augmented reality computing device 130 will enter sign-in credentials, such as username, and in other embodiments, a password, when prompted by UI control program 150. This allows UI control program 150 to retrieve the corresponding user preferences. The sign-in methods include, but are not limited to: (i) default users; (ii) guests; and (iii) allowing device use without a sign-in procedure.

The method to communicate over a network, such as network 120, see FIG. 1, (sometimes referred to as “data handshaking”) may include, but are not limited to: (i) emailing requests and responses, using possibly simple mail transfer protocol (SMTP); (ii) off-the-shelf or custom-developed applications that allow data transferring; (iii) extensible markup language (XML), or variations of such, one being “beep” (Blocks Extensible Exchange Protocol); (iv) transmission control protocol/internet protocol TCP/IP or its derivatives; (v) process communication, such as messaging; and (vi) using computer browsers for the inquiries and responses. For instance, using an off-the-shelf or custom-developed application, a transmission control protocol/internet protocol (TCP/IP) connection can be established to pass the data to and from preference repository 160. Preference repository 160 will be discussed in detail shortly.

In step 220, UI control program 150 receives parameters representing a user command. In one embodiment, sensors API 170 processes raw tactile sensor data into parameters representing the user command and passes the parameters to UI control program 150. Examples of user commands represented by parameters are shown in FIG. 4 as user-command 420. A parameter can take one or more implementation types; examples types include, but are not limited to: (i) number representations; (ii) alphanumeric strings; (iii) heterogeneous data; such as data stored in a database management system (DBMS); (iv) flat file record; and (v), alternatively or additionally, encrypted data.

An alternative embodiment of the present invention involves sensors API 170 minimally processing the raw data from the one or more tactile sensors. The computer instructions to translate the tactile sensor raw data into parameters representing a user command usable by UI control program 150 can be encapsulated within UI control program 150. In this embodiment, sensors API 170 is essentially a conduit for raw data from the tactile sensors to the UI control program 150.

An alternative embodiment of the present invention combines sensors API 170 and UI control program 150 in such a manner as to eliminate the need of communications between the programs.

An alternative embodiment of the present invention, not shown in Figures, involves having sensors API 170 encapsulated outside augmented reality computer device 130. For instance, sensors API 170 can exists on server computer 140, or a computer similar to server computer 140, which is accessible via network 120.

An alternative embodiment of the present invention, not shown in Figures, involves having tactile sensor(s) encapsulated outside the assembly of augmented reality computing device 130. Tactile sensors can exist on computing devices that simulate tactile sensors, or tactile sensors can be located on mock eyewear. For instance, simulating tactile sensors is beneficial in a development environment or in a testing environment. For instance, simulated tactile sensors can exist on server computer 140, or a computer similar to server computer 140, which is accessible via network 120.

In step 230, UI control program 150 determines a computer action based on the parameters representing the user command received in step 220. In one embodiment, UI control program 150 queries preference repository 160 in order to determine a computer action to be taken by augmented reality computing device 130. Preference repository 160 returns the computer action back to UI control program 150 via network 120. For instance, a user taps on the right lens of augmented reality computing device 130 once. When the tap occurs UI control program 150 determines, by querying preference repository 160, that the computer action is to move the content displayed at specific locations in both lenses of augmented reality computing device 130 to new specific locations slightly to the left.

In step 240, UI control program 150 provides the computer action to augmented reality computing device 130. In one embodiment, UI control program 150 issues commands to augmented reality computing device 130. The commands issued by UI control program 150 can take a form that includes, but is not limited to: (i) extensible markup language (XML); (ii) variations of such, one being “beep” (Blocks Extensible Exchange Protocol); (iii) transmission control protocol/internet protocol (TCP/IP) or its derivatives; (iv) process communication, such as messaging; and (v) any communication commands that are to be developed for data handshaking.

In step 250, UI control program 150 updates preference repository 160. The user of the augmented reality computing device 130 has control of his or her user preferences. A user can build a new preference, update existing preferences, or delete preferences from preference repository 160. Updating preference repository 160 involves data handshaking with preference repository 160 in a similar fashion, as formerly described, in step 210. In one embodiment, augmented reality computing device 130 has a standard default sensor that indicates to UI control program 150 to enter a mode where, after one or more user interactions, UI control program 150 stores the user's preference. There are many derivative embodiments that would control user interactions; however, the purpose would be similar—stores the user's preference in the repository.

In another embodiment, in step 250, UI control program 150 may enter a learning mode. Once a computer action is executed, via the previous step 240, the computer action is logged in order determine possible patterns based on how many times, and in what context, the user wanted a specific computer action. UI control program 150 learns from repeated user commands for a specific computer action, heuristically analyzing the user commands, and noting any correlation between the type of computer action and in what context the computer action is executed. Context may include the type of content displayed on augmented reality computing device 130 during the computer action or other variables existing during the computer action.

Other variables may include any information that may be determined by the tactile sensors on augmented reality computing device 130 or any information that may be determined by other sensors (not shown). For example, augmented reality computing device may contain an accelerometer that can sense movement. In addition to sensed information, context variables may include the collection of location, ambient, or environmental data around the augmented reality computing device when a specific computer action is logged such as sound, perspective, light, darkness, focus, temperature, time of day, location of the user, or objects within the view of the lens view of the augmented reality device. For example, a specific computer action may be performed on the augmented reality device when a user is at work on a weekday that may be differentiated from when the user is in a home environment. The collection of location, ambient, or environmental data can optionally be provided by a user or a service on behalf of a user. These context variables are meant to aid in the intelligence and training of the user intent for invoking a specific computer action to modify the display of content at a specific location on an augmented reality computing device.

A threshold for the number of times a user command is repeated in order to invoke UI control program 150 learning can be established. For example, the threshold can be, but is not limited to: (i) more than once; (ii) more than once with one or more commands intermingled; (iii) once, if always executed in similar context, such as, the very first command when UI control program 150 is powered on; and (vi) when the user starts walking. Examples of such heuristically learned correlations include, but are not limited to: (i) user always moves text to one eye—system learns to display text on that eye; (ii) user moves content out of the way when walking—system always moves content out of the way, in one or both lens, when the user begins a walking movement; and (iii) user always enlarges small or detailed content in one lens, this might indicate that one eye is worse, thus system would either regularly: (a) enlarge detailed content in that lens, (b) always display it in the other lens, or (c) take similar resulting action.

The logging method (in step 250) to manage the logging data can take any form that would facilitate storage and retrieval of information. Examples of the logging method would include, but are not limited to: (i) utilizing AR environmental variables; (ii) utilizing a database management system (DBMS) such as: (a) a relational database, (b) hierarchical database, (c) object-oriented database, (d) XML (Extendable Markup Language) database, etc.; (iii) utilizing a flat file; (iv) utilizing a table lookup scheme, such as a hash table software; or (v) utilizing any custom or off-the-shelf software that would manage the logging data. Additionally, the learned activity is stored in another repository similar to preference repository 160. Updating the learned activity involves communicating with the repository in a similar fashion, as formerly described, in step 210.

In another embodiment, in step 250 of UI control program 150, where UI control program 150 enters a heuristic learning mode, step 250 is implemented as a self-contained program. This embodiment of the present invention would perform all the functions described formerly in step 250. The embodiment would include a method of data handshaking of data between augmented reality computing device 130 and this alternative embodiment.

In decision 260, UI control program 150 determines if any further processing is necessary and if not UI control program 150 terminates. Step 260's implementation depends upon program implementation of augmented reality computing device 130, as someone skilled in the art would recognize. Examples of 260's implementation would include, but are not limited to: (i) simple termination; (ii) sleeping until interrupted; (iii) a signal shutdown; (iv) wait until a time event; (v) wait until a user event; (vi) loop forever; (vii) countdown loop; or (viii) any combination of such.

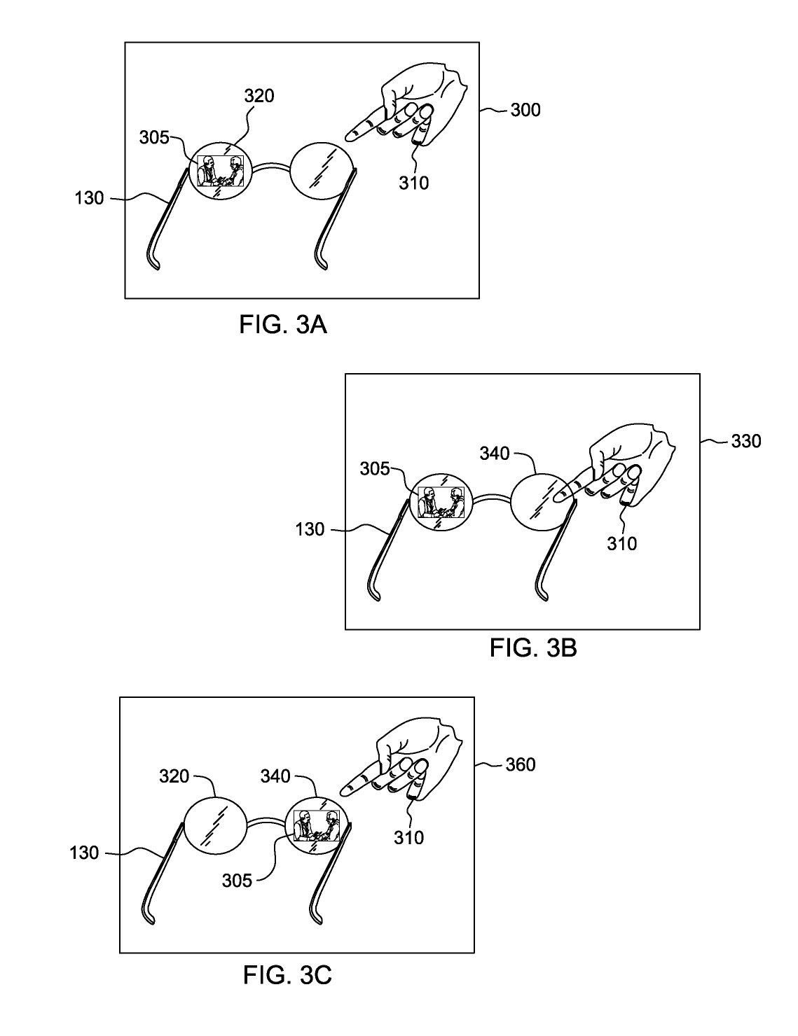

FIGS. 3A to 3C, in aggregate, illustrate one example of operational steps of UI control program 150, operating on augmented reality computing device 130 within data processing environment 100 of FIG. 1, in accordance with one embodiment of the present invention.

FIG. 3A, frame 300, contains augmented reality (AR) content 305 which is displayed at a specific location on left lens 320. A user's right hand 310 is in proximity of augmented reality computing device 130, yet far enough away not to trigger any tactile sensors. In frame 330, see FIG. 3B, the user performs a user command by touching right lens 340 (establishing enough contact, with one or more tactile sensors, to recognize a tactile trigger). In this example, the user touches right lens 340 using the index finger of right hand 310; however, this does not imply any special capability or quality attributed to the index finger over other methods of touching the tactile sensors of augmented reality computing device 130. Sensors API 170 recognizes the touch and passes the parameters representing the user command along to UI control program 150. UI control program 150 determines that the computer action is to move AR content 305 from a specific location on left lens 320, FIG. 3A, to a specific location on right lens 340, see FIG. 3C, frame 360.

In an alternative embodiment of the present invention the tactile sensor is in the assembly of augmented reality computing device 130. More specifically, the tactile senor is in one or both of the extending side-arms of augmented reality computing device 130 (not labeled, but shown in FIGS. 3A to 3C). The user grabs one side-arm with thumb and index finger (thumb below, index finger at top of assembly) and presses in with both. In this embodiment the parameters representing the user command can infer the same computer action as previously described for FIG. 3A to 3C, that is, AR content 305 switches to right lens 340 from left lens 320.

In an alternative embodiment of the present invention the lens-of-focus is highlighted as an indication to the user of the context in which he is manipulating the AR content. The lens-of-focus is the lens in which the user's intended computer action will be executed. For instance, in FIG. 3B the act of touching the right lens makes the right lens the lens-of-focus. Although, alternatively, depending on the information in preference repository 160 the touching of the right lens may activate the left lens to be the lens-of-focus. The form of highlight can, for example, alternatively or additionally, include, but is not limited to: (i) highlighting in a color or grayscale; (ii) highlighting as a ring around the lens-of-focus; (iii) highlighting the entire lens-of-focus; (iv) highlighting content; and (v) one or more flashing signals.

In FIG. 4, table 400 is a depiction, in tabular form, of preference repository 160, in accordance with one embodiment of the present invention.

Preference repository 160 is an information store of user's preferences for augmented reality computing device 130. The information store shown in FIG. 4, includes, but is not limited to: (i) a user-id (identification) 410 of one or more users, such as (a) a person's name, (b) a number, or (c) any alphanumeric string of characters that can be typed using a conventional computer keyboard; (ii) user-commands 420, such commands are represented by parameters received from sensors API 170; (iii) action 430, that indicates the action taken to modify the display of content at a specific location on an augmented reality computing device, given a corresponding user-command 420; and (iv) content-qualifier 440, which modifies action 430. Preference repository 160 can refer to an information store in the form of a: (i) database; (ii) flat file; (iii) or any structure that would facilitate access and security to such information. The information within the information store is obtainable through methods, whether custom or off-the-shelf, that facilitate access by authorized users. For example, such methods include, but are not limited to, a database management system (DBMS).

Example mappings from user-commands 420 to actions 430 are shown in FIG. 4. A user-id 410 may not contain an entry, thus, it is assumed that only one user is in play or default preferences will be used. Mappings for user-id 410: Sam, include, but are not limited to: (i) user-command 420: user taps on right lens once, action 430: content moves slightly left in both lenses; (ii) user-command 420: user taps on right lens once, action 430: content moves slightly left in lens containing email application, content-qualifier 440: email running; (iii) user-command 420: user taps on left lens once, action 430: content moves slightly right in both lenses; and (iv) user-command 420: user double taps right lens, action 430: content moves from right lens to left. Mappings for user-id 410: Martha, include, but are not limited to: (i) user-command 420: user taps on right lens once, action 430: content moves slightly left in both lenses; (ii) user-command 420: user taps on left lens once, action 430: content moves slightly right in both lenses; (iii) user-command 420: user double taps on right lens, action 430: content enlarges; and (iv) user-command 420: user taps both lenses essentially simultaneously, action 430: all content switches to opposing lenses, content-qualifier 440: user-defined-1. The content-qualifier 440 user-defined-1 is created specifically by a user who does not find the predefined standard user-commands 420 adequate. Content-qualifier 440 user-defined-1 allows for user commands to be extendable. Mappings for user-id 410: default, include, but certainly are not limited to: (i) user-command 420: user taps on right lens once, action 430: content moves slightly left in both lenses; (ii) user-command 420: user taps on left lens once, action 430: content moves slightly right in both lenses; (iii) user-command 420: user double taps on right lens, action 430: content moves from right lens to left.

Additional examples of mappings according to embodiments of the present invention, from user-commands 420 to actions 430, which are not shown in FIG. 4, include, but are not limited to: (i) user-command 420: user lifts glasses slightly off nose, action 430: content moves up in both lenses; (ii) user-command 420: user taps right lens on the upper right near hinge action 430: content moves down in only the right lens; (iii) user-command 420: user grabs right assembly with thumb and forefinger (thumb below, forefinger at top of assembly) and presses in with both, action 430: content reduces in size; (iv) user-command 420: user brushes top of right lens with a finger, going from nosepiece to outside of eye, action 430: content enlarges; (v) user-command 420: user triple taps either lens, action 430: content closes; (vi) user-command 420: user squeezes right earpiece, action 430: file menu opens for content on right eye; (vii) user-command 420: user may touch an area of the lens that is associated to actions 430, including, but not limited to: (a) maximizing content, (b) minimizing content, (c) opening/closing content in one or both lenses, (d) shifting content from left, right, up, down or between lenses, etc. and (viii) user-command 420: user touches side of eyewear and pushes in, action 430: indicate minimizing of overlaid objects.

Preferences repository 160 can be loaded, fully or partially, (i) into memory accessible by the UI control program 150 or (ii) continuously queried by UI control program 150. Such implementation differences would affect the data handshaking method described formerly in step 210.

FIG. 5 is a block diagram of components of augmented reality computing device 130 and server computer 140 in accordance with one embodiment of the present invention. It should be appreciated that FIG. 5 provides only an illustration of one implementation and does not imply any limitations with regard to the environments in which different embodiments may be implemented. Many modifications to the depicted environment may be made.

Augmented reality computing device 130 and server computer 140 each include communications fabric 502, which provides communications between computer processor(s) 504, memory 506, persistent storage 508, communications unit 510, and input/output (I/O) interface(s) 512. Communications fabric 502 can be implemented with any architecture designed for passing data and/or control information between processors (such as microprocessors, communications and network processors, etc.), system memory, peripheral devices, and any other hardware components within a system. For example, communications fabric 502 can be implemented with one or more buses.

Memory 506 and persistent storage 508 are computer-readable storage media. In this embodiment, memory 506 includes random access memory (RAM) 514 and cache memory 516. In general, memory 506 can include any suitable volatile or non-volatile computer-readable storage media.

Sensors API 170 and UI control program 150 are stored in persistent storage 508 of augmented reality computing device 130 for execution and/or access by one or more of the respective computer processors 504 of augmented reality computing device 130 via one or more memories of memory 506 of augmented reality computing device 130. Preference repository 160 is stored in persistent storage 508 of server computer 140 for execution and/or access by one or more of the respective computer processors 504 of server computer 140 via one or more memories of memory 506 of server computer 140. In this embodiment, persistent storage 508 includes a magnetic hard disk drive. Alternatively, or in addition to a magnetic hard disk drive, persistent storage 508 can include a solid state hard drive, a semiconductor storage device, read-only memory (ROM), erasable programmable read-only memory (EPROM), flash memory, or any other computer-readable storage media that is capable of storing program instructions or digital information.

The media used by persistent storage 508 may also be removable. For example, a removable hard drive may be used for persistent storage 508. Other examples include optical and magnetic disks, thumb drives, and smart cards that are inserted into a drive for transfer onto another computer-readable storage medium that is also part of persistent storage 508.

Communications unit 510, in these examples, provides for communications with other data processing systems or devices. In these examples, communications unit 510 includes one or more network interface cards. Communications unit 510 may provide communications through the use of either or both physical and wireless communications links. Sensors API 170 and UI control program 150 may be downloaded to persistent storage 508 of augmented reality computing device 130 through communications unit 510 of augmented reality computing device 130. Preference repository 160 may be downloaded to persistent storage 508 of server computer 140 through communications unit 510 of server computer 140.

I/O interface(s) 512 allows for input and output of data with other devices that may be connected to augmented reality computing device 130 or server computer 140. For example, I/O interface 512 may provide a connection to external devices 518 such as a keyboard, keypad, a touch screen, and/or some other suitable input device. External devices 518 can also include portable computer-readable storage media such as, for example, thumb drives, portable optical or magnetic disks, and memory cards. Software and data used to practice embodiments of the present invention, e.g., sensors API 170 and UI control program 150, can be stored on such portable computer-readable storage media and can be loaded onto persistent storage 508 of augmented reality computing device 130 via I/O interface(s) 512 of augmented reality computing device 130. Software and data used to practice embodiments of the present invention, e.g., preference repository 160, can be stored on such portable computer-readable storage media and can be loaded onto persistent storage 508 of server computer 140 via I/O interface(s) 512 of server computer 140. I/O interface(s) 512 also connect to a display 520.

Display 520 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A method for performing a computer action to manage a visual display on an augmented reality computing device, comprising the steps of:
receiving parameters representing a user command entered on at least one tactile sensor of an augmented reality computing device;
determining, by one or more processors, a computer action represented by the user command; and
modifying the display of content at a specific location on the augmented reality computing device, in response to determining the computer action.

2. The method of claim 1, further comprising the step of determining a type of the content displayed on the augmented reality computing device.

3. The method of claim 1, wherein the step of determining the computer action represented by the user command comprises determining that the parameters representing the user command match predefined parameters corresponding to a specific computer action.

4. The method of claim 1, further comprising the step of:
determining a pattern amongst a plurality of computer actions including the determined computer action, and updating a set of user preferences to contain a user preference based on the pattern.

5. The method of claim 1, further comprising the steps of:
determining a context existing when the parameters are received; and
logging the determined computer action and the context existing when the parameters are received.

6. The method of claim 5, further comprising the steps of:
identifying that the determined computer action and the context existing when the parameters are received have been logged a number of times exceeding a threshold; and
updating a set of user preferences to contain the determined computer action and the context existing when the parameters are received.

7. The method of claim 1, wherein the computer action is maximizing content, minimizing content, opening content, closing content, shifting content to the left, shifting content right, shifting content up, shifting content down, or shifting content between lenses.

8. A computer program product for performing a computer action to manage a visual display on an augmented reality computing device, the computer program product comprising:
one or more computer-readable storage media and program instructions stored on the one or more computer-readable storage media, the program instructions comprising:
program instructions to receive parameters representing a user command entered on at least one tactile sensor of an augmented reality computing device;
program instructions to determine a computer action represented by the user command; and
program instructions to modify the display of content at a specific location on the augmented reality computing device, in response to determining the computer action.

9. The computer program product of claim 8, further comprising program instructions, stored on the one or more computer-readable storage media, to determine a type of the content displayed on the augmented reality computing device.

10. The computer program product of claim 8, wherein the program instructions to determine the computer action represented by the user command comprise program instructions to determine that the parameters representing the user command match predefined parameters corresponding to a specific computer action.

11. The computer program product of claim 8, further comprising program instructions, stored on the one or more computer-readable storage media, to determine a pattern amongst a plurality of computer actions including the determined computer action, and update a set of user preferences to contain a user preference based on the pattern.

12. The computer program product of claim 8, further comprising program instructions, stored on the one or more computer-readable storage media, to:
determine a context existing when the parameters are received; and
log the determined computer action and the context existing when the parameters are received.

13. The computer program product of claim 12, further comprising program instructions, stored on the one or more computer-readable storage media, to:
identify that the determined computer action and the context existing when the parameters are received have been logged a number of times exceeding a threshold; and
update a set of user preferences to contain the determined computer action and the context existing when the parameters are received.

14. The computer program product of claim 8, wherein the computer action is maximizing content, minimizing content, opening content, closing content, shifting content to the left, shifting content right, shifting content up, shifting content down, or shifting content between lenses.

15. A computer system for performing a computer action to manage a visual display on an augmented reality computing device, the computer system comprising:
one or more computer processors;
one or more computer-readable storage media;
program instructions stored on the computer-readable storage media for execution by at least one of the one or more processors, the program instructions comprising:
program instructions to receive parameters representing a user command entered on at least one tactile sensor of an augmented reality computing device;
program instructions to determine a computer action represented by the user command; and
program instructions to modify the display of content at a specific location on the augmented reality computing device, in response to determining the computer action.

16. The computer system of claim 15, further comprising program instructions, stored on the computer-readable storage media for execution by at least one of the one or more processors, to determine a type of the content displayed on the augmented reality computing device.

17. The computer system of claim 15, wherein the program instructions to determine the computer action represented by the user command comprise program instructions to determine that the parameters representing the user command match predefined parameters corresponding to a specific computer action.

18. The computer system of claim 15, further comprising program instructions, stored on the computer-readable storage media for execution by at least one of the one or more processors, to determine a pattern amongst a plurality of computer actions including the determined computer action, and update a set of user preferences to contain a user preference based on the pattern.

19. The computer system of claim 15, further comprising program instructions, stored on the computer-readable storage media for execution by at least one of the one or more processors, to:
determine a context existing when the parameters are received; and
log the determined computer action and the context existing when the parameters are received.

20. The computer system of claim 19, further comprising program instructions, stored on the computer-readable storage media for execution by at least one of the one or more processors, to:
identify that the determined computer action and the context existing when the parameters are received have been logged a number of times exceeding a threshold; and
update a set of user preferences to contain the determined computer action and the context existing when the parameters are received.
